(19) United States
(12) Patent Application Publication
(10) Pub. No.: US 2013/0146786 A1
(43) Pub. Date: Jun. 13, 2013

(54) APPARATUS FOR GENERATING FLUORESCENCE

(71) Applicants: Ping-Hua TENG, Taichung City (TW); Cheng SU, Taichung City (TW)

(72) Inventors: Ping-Hua TENG, Taichung City (TW); Cheng SU, Taichung City (TW)

(21) Appl. No.: 13/315,658

(22) Filed: Dec. 9, 2011

(51) Int. Cl. G01N 21/64

(52) U.S. Cl. 250/458.1

(57) ABSTRACT

An apparatus for generating fluorescence comprises a blue LED emitting a light beam, a filter and a fluorescent material. The filter is arranged in front of the light beam emitted by the blue LED, receives the light beam, and converts the light beam into a filtered light beam having wavelengths of 465-505 nm. The fluorescent material is arranged in one side of the filter, which is opposite to the blue LED, to receive the filtered light beam. The fluorescent material is excited by the filtered light beam to emit fluorescence. The filter is applied to control the wavelength and spectral range of the filtered light beam to achieve the best fluorescence exciting efficiency and prevent from the overlap of the wavelength ranges of the filtered light beam and the fluorescence.

### FIELD OF THE INVENTION

The present invention relates to an apparatus for generating light, particularly to an apparatus for generating fluorescence.

### BACKGROUND OF THE INVENTION

In examination of genetics, molecular biology and animal/plant quarantine, a trace nucleic acid sample is fast amplified to a detectable amount via a nucleic acid amplification method, such as PCR (Polymerase Chain Reaction). The target nucleic acid of the reaction product is combined with a nucleic acid probe carrying a fluorescent material, a radioactive material or a coloring enzyme via a hybridization reaction, whereby the target nucleic acid can present fluorescence, radioactive images, or colors. The fluorescent reagent is 10³ to 5×10⁵ times more sensitive than the conventional coloring reagent. Therefore, many current biochips adopt fluorescent reagents to label the target materials.

Fluorescent images are observed, detected, analyzed, and captured with fluorescence microscopy, fluorometry, flow cytometry and photography. A specified fluorescent reagent needs an exciting light source having a specified range of wavelength. Therefore, the abovementioned technologies all involve adopting an exciting light source. When illuminated with an appropriate wavelength of light, a fluorescent material is exited to a high energy level. Then, the excited fluorescent molecule returns to a low energy level within a very short interval of time (10⁻⁸-10⁻⁴ sec) and releases the redundant energy in form of light. Therefore, a specified fluorescent reagent needs a matching exciting light source to achieve the best performance.

The exciting light sources include ultraviolet rays or laser beams. However, ultraviolet ray is likely to scatter and hard to transmit and penetrate. Thus, the ultraviolet-based test devices have to adopt special optical elements to enhance the sensitivity to ultraviolet rays. Therefore, the ultraviolet-based test devices are high-priced and economically inefficient. The laser beam is monochromatic, penetrative and easy to detect. However, the laser-based test devices need filters and splitters, which makes them bulky and hard to install.

Therefore, the conventional technique discloses a LED (Light Emitting Diode) module whose light intensity and combination of light colors can be adjusted, wherein the combination of the light colors is adjusted to obtain the wavelengths of lights able to excite the fluorescent reagent. However, only a specified wavelength of exciting light can attain higher exciting efficiency. Further, the wavelength range of the LED module may overlap the wavelength range of the excited fluorescent reagent. It is hard to determine whether the detected light intensity comes from purely the excited fluorescence or from both the excited fluorescence and the exciting light. Thus, the laser-based test devices may have poorer precision.

### SUMMARY OF THE INVENTION

The primary objective of the present invention is to provide an exiting light source having a specified wavelength range to effectively excite fluorescence.

Another objective of the present invention is to solve the fluorescence detection problem caused by the fact that the wavelength range of the exciting light source is likely to overlap the wavelength range of the excited fluorescence.

To achieve the abovementioned objectives, the present invention proposes an apparatus for generating fluorescence, which comprises a blue LED emitting a light beam, a filter and a fluorescent material. The filter is arranged in front of the light beam emitted by the blue LED, receives the light beam and converts the light beam into a filtered light beam having wavelengths of 465-505 nm. The fluorescent material is arranged in one side of the filter and opposite to the blue LED and excited by the filtered light beam to emit fluorescence.

The present invention has the following characteristics:
1. The filter controls the filtered light beam to have wavelengths of 465-505 nm, whereby the precisely controlled wavelength of light can efficiently excite the fluorescent material to emit fluorescence.

2. The wavelength range of the filtered light beam can be adjusted to prevent from measurement errors caused by coincidence or overlap of the wavelength ranges of the filtered light beam and the excited fluorescence.

### BRIEF DESCRIPTION OF THE DRAWINGS

FIG. 1 is a block diagram schematically showing the architecture of an apparatus for generating fluorescence according to one embodiment of the present invention;

FIG. 2 is a perspective view schematically showing an apparatus for generating fluorescence according to one embodiment of the present invention; and

FIG. 3 is a diagram showing a spectrum of a light beam.

### DETAILED DESCRIPTION OF THE PREFERRED EMBODIMENTS

The technical contents of the present invention are described in detail in cooperation with drawings below.

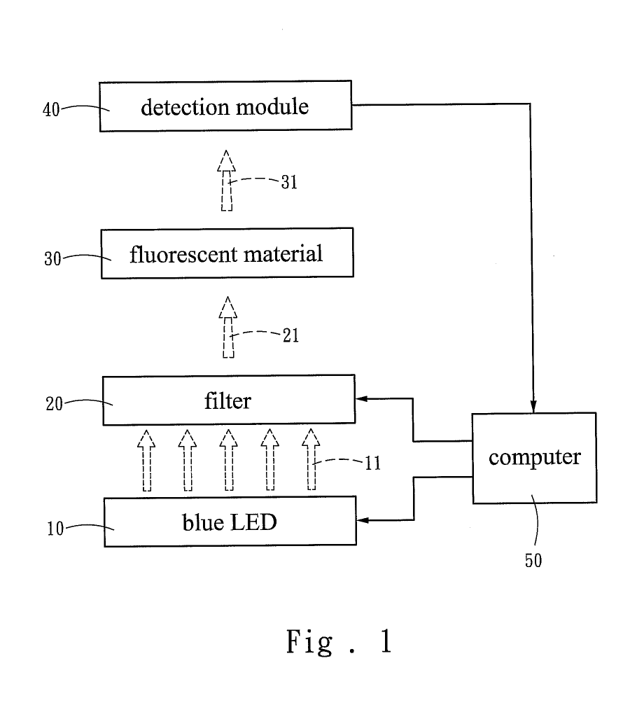

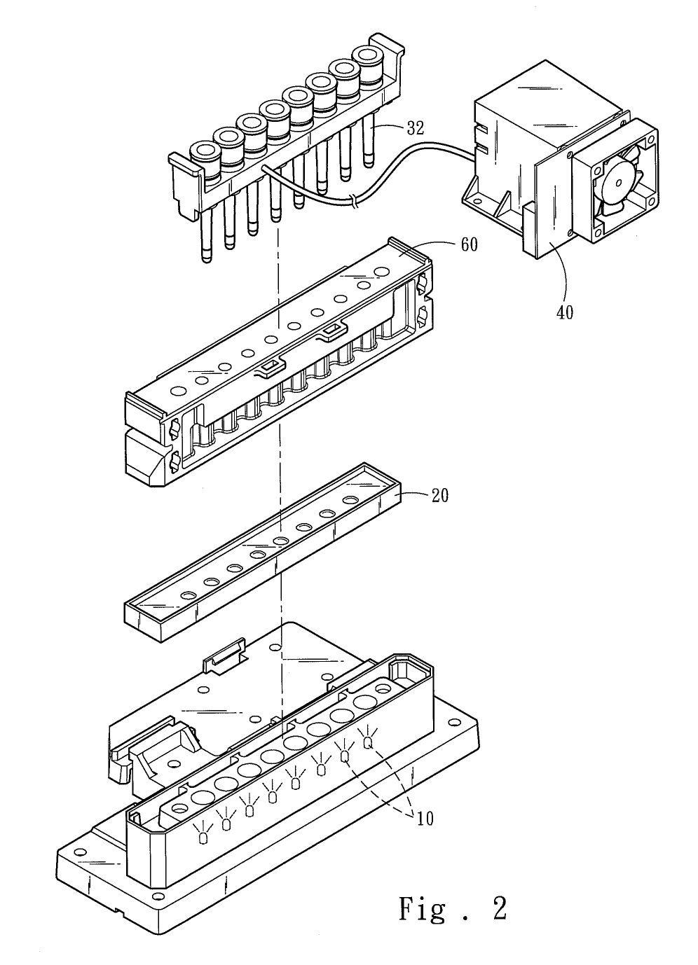

Refer to FIG. 1 and FIG. 2. The present invention proposes an apparatus for generating fluorescence, which comprises a blue LED 10 emitting a light beam 11, a filter 20 and a fluorescent material 30. The filter 20 is arranged in front of the light beam 11 emitted by the blue LED 10 to receive the light beam 11 and convert the light beam 11 into a filtered light beam 21 having wavelengths of 465-505 nm. The fluorescent material 30 is placed in a test tube 32. The test tube 32 is arranged in one side of the filter 20, which is opposite to the blue LED 10. The fluorescent material 30 receives the filtered light beam 21 and is excited by the filtered light beam 21 to emit fluorescence 31. A detection module 40 detects the spectrum of the fluorescence 31. In one embodiment, a computer 50 is connected with the blue LED 10, the filter 20 and the detection module 40. The computer 50 controls the on/off operations and intensity of the blue LED 10 and the wavelength range of the filtered light beam 21 of the filter 20. The computer 50 also receives information from the detection module 40. In one embodiment, a heater 60 is used to facilitate PCR.

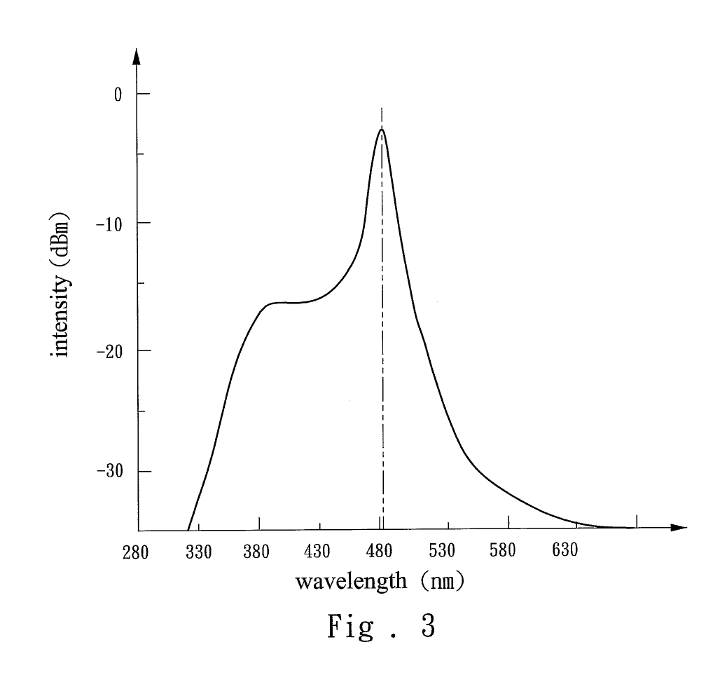

Refer to FIG. 3. In a spectrum of light, an intensity peak exists within a specified range of wavelengths, and the intensity of the light gradually decreases in two sides of the peak. The wavelength of a light is normally referred to the wavelength where the peak exists. The statement that a light has a given wavelength doses not necessarily means that the light has only a single wavelength but normally means that there is a peak appearing at the specified wavelength. For example, when a light has a wavelength of 488 nm, the light has an intensity peak at the wavelength of 488 nm and has lower intensities in two sides of the wavelength of 488 nm. If the intensity distribution of the light beam 11 emitted by the blue LED 10 is not convergent sufficiently, the wavelength range of the light beam 11 may overlap the wavelength range of the excited fluorescence 31. In such a case, the detection module 40 may also detect the energy of the light beam 11 and thus has a detection error. Therefore, the present invention uses the filter 20 to process the light beam 11 emitted by the blue LED 10 and obtain the filtered light beam 21, and uses the filtered light beam 21 to excite the fluorescent material 30.

The fluorescent material 30 could be 6-FAM, 5-FAM, Oregon Green-488, Alexa-488, Calcein, Cyanine-2, FAM, FITC (fluorescein isothiocyanat), FluorX, GFP, rsGFP, Oregon Green-500, Rhodamine 110, Rhodamine green, or SYBR green. The filter 20 is adjusted to emit a filtered light beam 21 having a wavelength of 492 nm for exciting the fluorescent material 30 of 6-FAM to emit fluorescence 31 having a wavelength of 517 nm, whereby the fluorescence exciting has the best efficiency. When the fluorescent material 30 is 5-FAM, the filter 20 is adjusted to emit a filtered light beam 21 having a wavelength of 494 nm to excite fluorescence 31 having a wavelength of 518 nm. When the fluorescent material 30 is Oregon Green-488, the filter 20 is adjusted to emit a filtered light beam 21 having a wavelength of 496 nm to excite fluorescence 31 having a wavelength of 524 nm. When the fluorescent material 30 is Alexa-488, the filter 20 is adjusted to emit a filtered light beam 21 having a wavelength of 495 nm to excite fluorescence 31 having a wavelength of 520 nm. When the fluorescent material 30 is Calcein, the filter 20 is adjusted to emit a filtered light beam 21 having a wavelength of 494 mn to excite fluorescence 31 having a wavelength of 517 nm. When the fluorescent material 30 is Cyanine-2, the filter 20 is adjusted to emit a filtered light beam 21 having a wavelength of 489 nm to excite fluorescence 31 having a wavelength of 506 nm. When the fluorescent material 30 is FAM, the filter 20 is adjusted to emit a filtered light beam 21 having a wavelength of 488 nm to excite fluorescence 31 having a wavelength of 508 nm. When the fluorescent material 30 is FITC, the filter 20 is adjusted to emit a filtered light beam 21 having a wavelength of 494 nm to excite fluorescence 31 having a wavelength of 518 mn. When the fluorescent material 30 is FluorX, the filter 20 is adjusted to emit a filtered light beam 21 having a wavelength of 494 nm to excite fluorescence 31 having a wavelength of 519 nm. When the fluorescent material 30 is GFP, the filter 20 is adjusted to emit a filtered light beam 21 having a wavelength of 488 nm to excite fluorescence 31 having a wavelength of 558 nm. When the fluorescent material 30 is rsGFP, the filter 20 is adjusted to emit a filtered light beam 21 having a wavelength of 488 nm to excite fluorescence 31 having a wavelength of 507 nm. When the fluorescent material 30 is Oregon Green-500, the filter 20 is adjusted to emit a filtered light beam 21 having a wavelength of 503 nm to excite fluorescence 31 having a wavelength of 522 nm. When the fluorescent material 30 is Rhodamine 110, the filter 20 is adjusted to emit a filtered light beam 21 having a wavelength of 496 nm to excite fluorescence 31 having a wavelength of 520 nm. When the fluorescent material 30 is Rhodamine green, the filter 20 is adjusted to emit a filtered light beam 21 having a wavelength of 502 nm to excite fluorescence 31 having a wavelength of 527 nm. When the fluorescent material 30 is

SYBR green, the filter 20 is adjusted to emit a filtered light beam 21 having a wavelength of 497 nm to excite fluorescence 31 having a wavelength of 520 nm.

In the present invention, the filter 20 is adjusted to emit a filtered light beam 21 having a specified wavelength range able to achieve the best fluorescence exciting efficiency. The filter 20 controls the intensity of the filtered light beam 21 to be distributed within the range of the nominal wavelength thereof ±15 nm, and the intensity of the filtered light beam 21 approaches zero outside the abovementioned range. Further, the nominal wavelength of the fluorescence 31 of the fluorescent material 30 excited by the filtered light beam 21 is far away from the nominal wavelength of the filtered light beam 21 by at least 15 nm. Therefore, the wavelength range of the fluorescence 31 would not overlap the wavelength range of the filtered light beam 21. Thus, the detection would not be affected by the overlap of wavelength ranges.

In conclusion, the present invention uses only a blue LED 10 to excite the fluorescence 31 and uses a filter 20 to control the wavelength and spectral range of the filtered light beam 21 to achieve the best fluorescence exciting efficiency. Further, the present invention also uses the filter 20 to prevent from the overlap of the wavelength ranges of the filtered light beam 21 and the fluorescence 31. Thus, the detection module 40 is exempted from being affected by overlap of wavelength ranges in measuring the intensity of the fluorescence 31.

What is claimed is:

1. An apparatus for generating fluorescence comprising
a blue light emitting diode (LED) emitting a light beam;
a filter arranged in front of the light beam to receive the light beam and convert the light beam into a filtered light beam having a wavelength of 465-505 nm; and
a fluorescent material arranged in one side of the filter, which is opposite to the blue LED, the fluorescent material receiving the filtered light beam and being excited by the filtered light beam to emit fluorescence.

2. The apparatus for generating fluorescence according to claim 1, wherein the fluorescent material is selected from a group consisting of 6-FAM, 5-FAM, Oregon Green-488, Alexa-488, Calcein, Cyanine-2, FAM, FITC (fluorescein isothiocyanat), FluorX, GFP, rsGFP, Oregon Green-500, Rhodamine 110, Rhodamine green, and SYBR green.
